(19) United States
(12) Patent Application Publication
(10) Pub. No.: US 2015/0370431 A1
(43) Pub. Date: Dec. 24, 2015

(54) System and Method for Document-Portion Social Networking

(71) Applicant: GLOSE SAS, Paris (FR)

(72) Inventors: Nicolas Princen, Neuilly sur Seine (FR); Julien Chaumond, Paris (FR); Arthur Darcet, Neuilly sur Seine (FR)

(73) Assignee: GLOSE SAS, Paris (FR)

(21) Appl. No.: 14/743,732

(22) Filed: Jun. 18, 2015

Related U.S. Application Data
(60) Provisional application No. 62/013,895, filed on Jun. 18, 2014.

(51) Int. Cl. G06F 3/0483; G06F 17/24

(52) U.S. Cl. CPC G06F 3/0483; G06F 17/241

(57) ABSTRACT

A system and method for document portion social networking is disclosed.

### CROSS-REFERENCE TO RELATED APPLICATIONS

This application is a non-provisional from, and claims the benefit of U.S. Provisional Application No. 62/013,895 filed Jun. 18, 2014, which application is hereby incorporated herein by reference in its entirety for all purposes.

### BACKGROUND

Electronic books (e-books) are a rapidly growing media. In the United States, it has already grown to a market share of 30% of total book sales. The e-book market first developed on devices that were specifically designed for reading, equipped with an epaper-like screen. Since the democratization of this market, e-book consumers have started leaving behind those simple, specialized devices and moving towards more versatile, multipurpose multimedia and personal computing devices like tablets, personal computers, and mobile phones. However, the existing e-book reading applications have yet to exploit all the opportunities to interact with texts provided by modern computing devices. In particular, the age-old practice of physically annotating a document alongside the text body itself has little digital counterpart.

In view of the foregoing, a need exists for improved social networking systems and methods related to portions of documents, including e-books, in an effort to overcome the aforementioned obstacles and deficiencies of conventional systems.

### BRIEF DESCRIPTION OF THE DRAWINGS

FIG. 1 is an exemplary network diagram illustrating an embodiment of a document-portion social network.

FIG. 2 is an exemplary drawing illustrating an embodiment of an interface for social networking based on a document-portion.

FIG. 3 is an exemplary data-flow diagram illustrating an embodiment of social networking based on a document-portion.

FIG. 4 is an exemplary block diagram illustrating an embodiment of a document-portion social networking method.

It should be noted that the figures are not drawn to scale and that elements of similar structures or functions are generally represented by like reference numerals for illustrative purposes throughout the figures. It also should be noted that the figures are only intended to facilitate the description of the preferred embodiments. The figures do not illustrate every aspect of the described embodiments and do not limit the scope of the present disclosure.

### DETAILED DESCRIPTION OF THE PREFERRED EMBODIMENTS

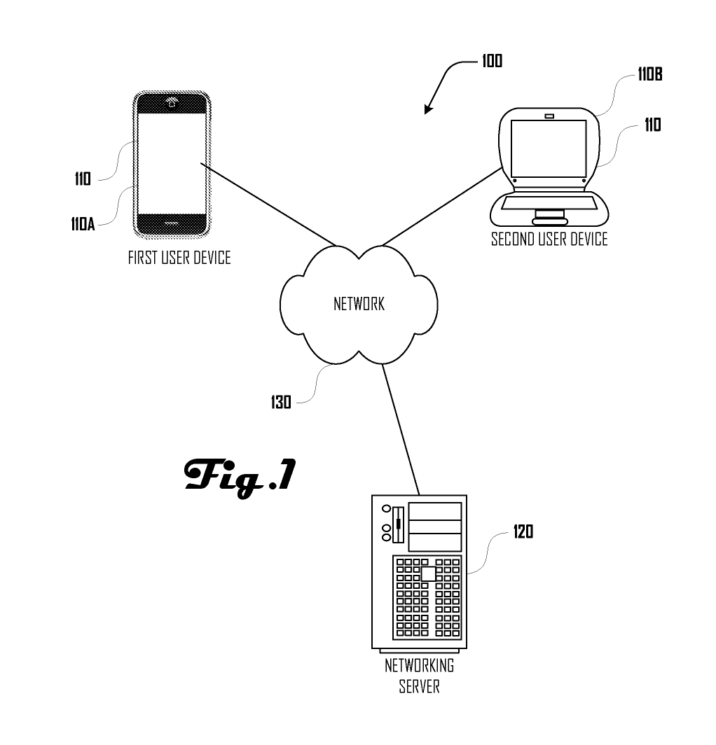

Turning to FIG. 1, the document-portion social network system 100 is shown as comprising a first and second user device 110A, 110B, and a networking server 120 that are operably connected via a network 130. Although the user devices 110A, 110B are depicted as being a smartphone and laptop computer respectively, in various embodiments, a user device 110 may be any suitable device, including a tablet computer, gaming device, desktop computer, or the like. Additionally, various embodiments may include any suitable plurality of user devices 110 and any suitable number of users. The networking server 120 may comprise one or more server or other suitable computer system, and may include a cloud-based system, or the like. The network 130 may comprise one or more suitable wireless or wired networks including the Internet, a wide fidelity (WiFi) network, a local area network (LAN), or the like.

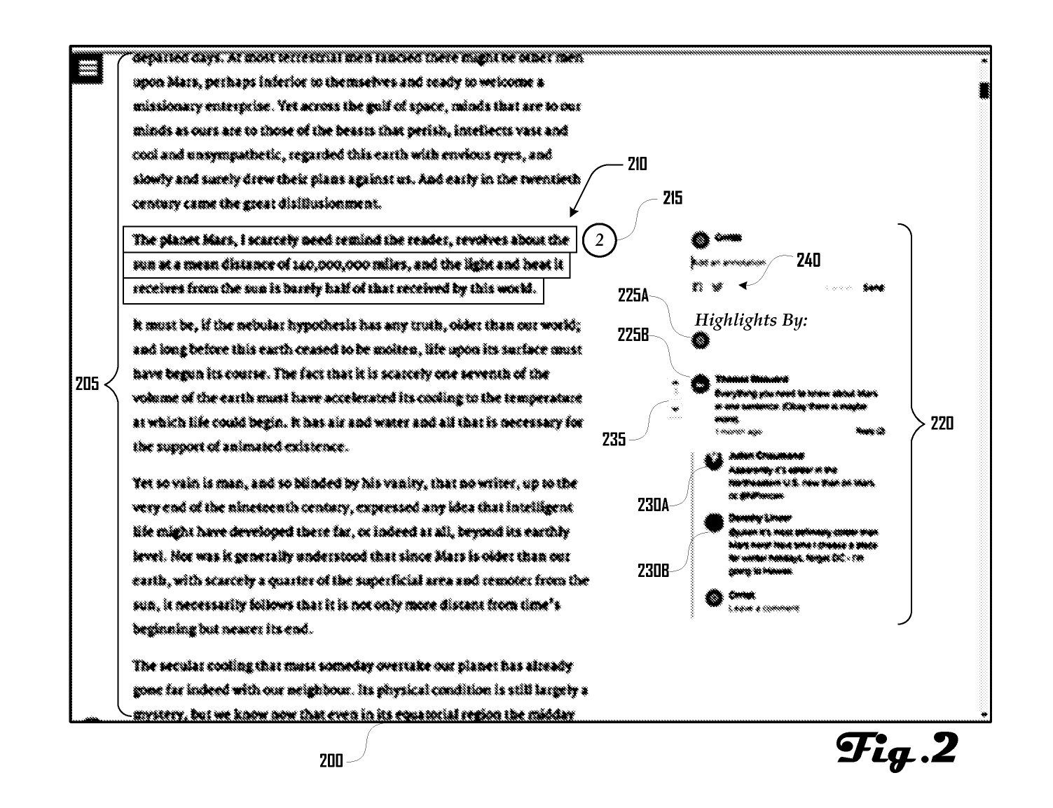

FIG. 2 is an exemplary drawing illustrating an embodiment of an interface 200 for social networking based on a document-portion 210. For example, in some embodiments a document may be an e-book that comprises a plurality of text 205 and other media such as images and the like. As discussed herein, the e-book may be parsed into a plurality of portions, which in some embodiments may be parsing into sentences. As shown in FIG. 2, a portion 210 of the text 205 (in this case a sentence) has been selected, which allows for social networking functionalities associated with that portion 210. For example a networking field 220 may appear to one side of the text 205 and proximate to the portion 210, which includes a plurality of highlight indicators 225A, 225B that are associated with one or more user. Highlight indicators may include a comment, annotation, or the like. Users may also provide comments or annotations in response to or associated with a given user highlight. For example, sub-comments 230A, 230B are provided in response to primary annotation 225B. Other functionalities that may be present in a networking field 220 may include an annotation promoter button 235, which allows users to promote or demote a given annotation (e.g. annotation 225B as depicted in FIG. 2). Users may also be able to share content via other social networks such as Facebook, Pinterest, and Twitter, via sharing buttons 240.

In various embodiments, the interface 200 may provide for viewing a document and text 205 within a document, and also provide for selective social networking associated with specific portions 215 of the document. For example, a user may be reading the text 205 of an e-book in a reading configuration where the networking field 220 is not displayed, and annotation indicators 215 may be present proximate to a portion 210 that has annotations associated with it. As shown in FIG. 2, the annotation indicator 215 indicates that there are two (2) annotations associated with portion 210. If the users desire to make an annotation associated with the same portion 215, view annotations and/or comments by other users, view annotation or comments that they made, or the like, users may select the portion 210 and the networking field 220 may be presented proximate to the selected portion 210.

In various embodiments, users may select any portion 210 (which may be a sentence of the document), which can generate a highlight, comment or other association with the selected portion 210. In various embodiments, by selecting a given portion 210, the user may automatically be associated, highlight or comment on the portion 210 without further interaction. Selection may occur via a click, tap, long click, long tap, or any other suitable selection method that may include use of a touchscreen, mouse or other suitable device.

In various embodiments, there may be social networking sites corresponding to users, documents or portions of documents. For example, each user may have a user profile that includes annotations that the user has made associated with a given portion along with the corresponding text or other media that defines the portion. There may also be a site for a given document (e.g., a site for a given e-book), that includes annotations that have been made by users associated with that document or associated with portions of the document. There may also be a site for each portion of a document, which includes annotations that have been made by users associated with that portion of the document.

In some embodiments, users may apply filters to annotations, highlights or comments that are displayed in a document or on various sites. For example, filters may include “me,” “friends,” “everybody,” “group,” or the like. A “me” filter may cause only annotations, highlights or posts made by the user be displayed. A “friends” filter may cause only annotations, highlights or posts made by the user and friends of the user be displayed. An “everybody” filter may cause all annotations, highlights or posts to be displayed. A “group” filter may cause only annotations, highlights or posts made by the users within a defined group to be displayed.

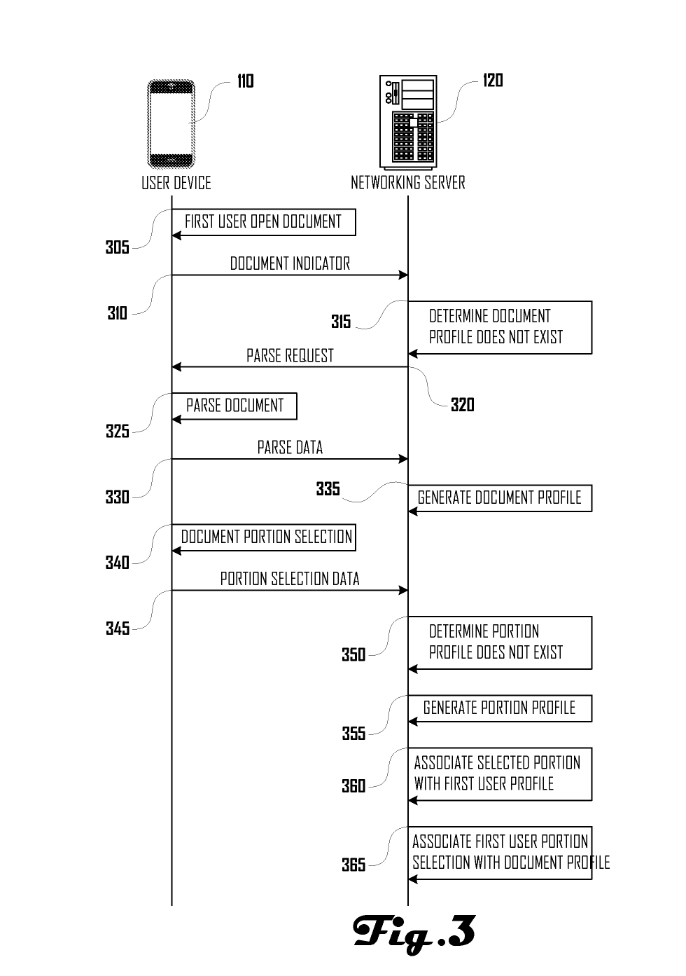

Turning to FIG. 3, data flow between a user device 110 and networking server 120 is depicted illustrating an embodiment of social networking based on a document-portion. In this embodiment, a new document is introduced to the system by a user device 110, but the document is yet to be parsed. The data flow begins at 305, where a first user opens a document, which in some embodiments may be an e-book. A document indicator is sent to the networking server 120, at 310, where a determination is made that a document profile does not exist for the document that the user opened. A parse request is sent to the user device 110, at 320, where the document is parsed, at 325, and parse data is sent to the networking server 120, at 330.

Although the present embodiment depicts parsing occurring at the user device 110, and the document being stored at the user device 110, in various embodiments, parsing may occur at the networking server 120, and documents may be stored at the networking server 120. For example, in one alternative embodiment, a document that has already been parsed may be stored on the networking server and sent to the user device 110. In another example, a document may be sent to the networking server 120 from the user device 110, where the document is parsed and sent back to the user device 110. Accordingly, the steps of parsing and storing a document before and after parsing, along with storing and sending parsing data should not be construed to be limited by the presently disclosed example embodiments.

Returning to the data flow of FIG. 3, a document profile is generated, at 335. At 340, a document-portion (e.g., a sentence 210 as depicted in FIG. 2) is selected and portion selection data is sent to the networking server 120, at 345. At 350, a determination is made that a portion profile does not exist that corresponds to the selected portion of the document, and at 355, a portion profile for the selected portion is generated. The selected portion is associated with a first user profile, at 360. The first user portion selection is associated with the document profile, at 365.

For example, a user may desire to include an e-book in the document-portion social networking system, the e-book may accordingly be parsed into sentences so that the sentences (i.e., portions) may be annotated, commented on, or highlighted by the user and others. In various embodiments, by parsing the e-book, a profile for the e-book may be automatically generated, which includes a site for the e-book that can display annotations, highlights or comments related to portions of the e-book. When a user selects a portion that has not been selected yet, this selection may generate a profile for the portion, which may include a site for the portion that can display annotations, highlights or comments related to that portion of the e-book. When users select a portion, that selection causes association of that portion with the user's profile, and may also make that selection (and annotations, highlights and/or comments associated with the selection) associated with the e-book profile and portion profile such that the selection (and annotations, highlights and/or comments associated with the selection) can be displayed on the user's profile site, the e-book profile site, and the portion profile site.

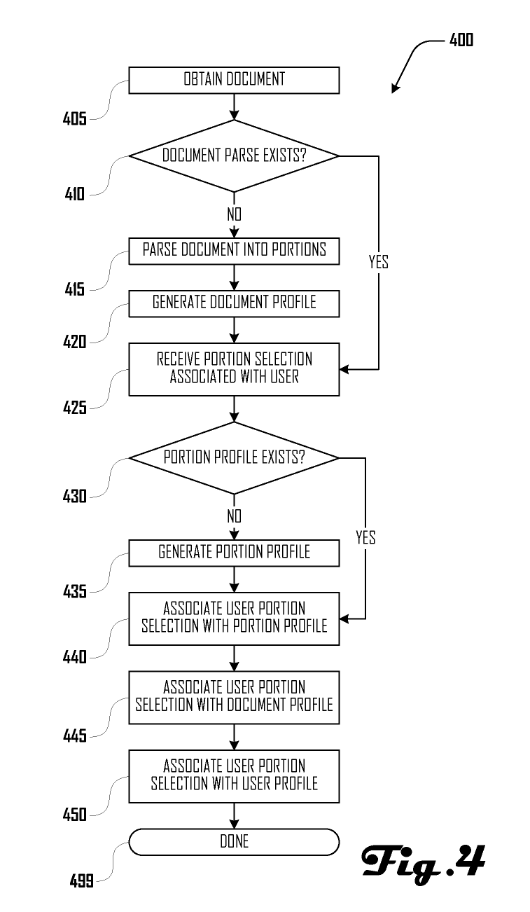

FIG. 4 is an exemplary block diagram illustrating an embodiment of a document-portion social networking method 400. The method 400 begins in block 405 where a document is obtained, and in block 410 a determination is made whether a document parse exists for the document. If a document parse exists, then the method 400 continues to block 425 discussed below. However, if no document parse exists, then in block 415, the document is parsed into portions. Portions may be a sentence, paragraph, page, word, letter, piece of media, or any other suitable portion of a document. Portions may be mutually exclusive or a part of one portion may be a part of another portion in some embodiments.

In block 420, a document profile is generated, and in block 425, a portion selection associated with a user is received. In decision block 430, a determination is made whether a portion profile exists, and if so, the method 400 continues to block 440 as discussed below. However, if a portion profile does not exist for the selected portion of the document, then a portion profile is generated in block 435, and in block 440, the user portion selection is associated with the portion profile. In block 445, the user portion selection is associated with the document profile. In block 450, the user portion selection is associated with the user's profile.

The described embodiments are susceptible to various modifications and alternative forms, and specific examples thereof have been shown by way of example in the drawings and are herein described in detail. It should be understood, however, that the described embodiments are not to be limited to the particular forms or methods disclosed, but to the contrary, the present disclosure is to cover all modifications, equivalents, and alternatives.

What is claimed is:

1. A method for document portion social networking, the method comprising:
obtaining a document;
determining that a document parse does not exist associated with the document;
parsing the document into portions;
generating a document profile;
receiving a document portion selection of a portion of the document, the portion selection being associated with a user profile;
determining that a portion profile associated with the portion of the document does not exist;
generating a portion profile associated with the selected portion of the document;
associating the portion profile with the user profile;
associating the portion selection with the document profile; and

[symbol]

2. The method of claim 1, wherein the document is an e-book.

3. The method of claim 1, wherein parsing the document comprises parsing the document into sentences.

4. The method of claim 1, further comprising:
displaying a portion of the document including the selected portion; and
displaying an indication that the selected portion is associated with the portion profile.

5. The method of claim 4, wherein displaying an indication that the selected portion is associated with the portion profile comprises highlighting the text of the selected portion.

6. The method of claim 4, further comprising displaying a social networking field proximate to and associated with the selected portion.

7. The method of claim 6, wherein the social networking field comprises one or more user annotation associated with the selected portion.

8. The method of claim 7, wherein the social networking field comprises a plurality of comments each associated with a different user of a plurality of users.

9. The method of claim 7, wherein the social networking field comprises an annotation promoter button configured to allow users to promote or demote a selected annotation.

10. The method of claim 1, wherein a user profile comprises a social networking site configured to indicate documents associated with the user profile; display document portions associated with the user profile; display annotations of one or more document portions associated with the user profile; and indicate annotation promotions or demotions associated with the user profile.

11. The method of claim 1, wherein the document profile comprises a social networking site configured to indicate user profiles associated with the document; indicate document portion profiles associated with the document profile; and display annotations associated with the document profile.

12. The method of claim 1, wherein the portion profile comprises a social networking site configured to display the selected portion and to display annotations that are associated with the portion profile.
